(19) United States
(12) Patent Application Publication
(10) Pub. No.: US 2026/0302068 A1
(43) Pub. Date: Oct. 1, 2026

(54) CERAMIC COMPONENT

(71) Applicant: Panasonic Intellectual Property Management Co., Ltd., Osaka (JP)

(72) Inventor: Yuji KURACHI, Hokkaido (JP)

(21) Appl. No.: 19/571,927

(22) Filed: Mar. 19, 2026

(30) Foreign Application Priority Data
Mar. 25, 2025 (JP) 2025-050482
Mar. 25, 2025 (JP) 2025-050483

(51) Int. Cl. H01G 4/224; C04B 35/453; H01C 1/032; H01C 7/00; H01G 4/12; H01G 4/30

(52) U.S. Cl. CPC H01G 4/224; C04B 35/453; H01C 1/032; H01G 4/1209; C04B 2235/3284; C04B 2235/3418; H01C 7/008; H01G 4/30

(57) ABSTRACT

A ceramic component of the present disclosure includes a ceramic body, an internal electrode in an interior of the ceramic body, an insulating layer covering a surface of the ceramic body, and an external electrode covering part of the insulating layer and electrically connected to the internal electrode. The insulating layer includes a buffer layer in contact with at least one of the ceramic body or the external electrode.

### CROSS-REFERENCE OF RELATED APPLICATIONS

The present application is based upon and claims the benefit of priority to Japanese Patent Application No. 2025-050482, filed on Mar. 25, 2025 and Japanese Patent Application No. 2025-050483, filed on Mar. 25, 2025, the entire contents of which are incorporated herein by reference.

### TECHNICAL FIELD

The present disclosure relates to ceramic components and specifically relates to a ceramic component including an insulating layer.

### BACKGROUND ART

Various types of electronic apparatuses, electronic devices, etc., include various ceramic components such as varistors. The varistors are used, for example, for the following purposes: protecting the various types of electronic apparatuses, electronic devices, etc., from an abnormal voltage caused by a lightning surge, static electricity, etc.; and preventing malfunctioning of the electronic apparatuses, the electronic devices, etc., due to noise generated in circuits.

JP 2007-080950 A discloses a laminated chip varistor including: a laminated body including a varistor layer and internal electrodes disposed to sandwich the varistor layer; and external electrodes on surfaces of the laminated body and connected to the internal electrodes. The laminated chip varistor of JP 2007-080950 A includes no insulating layer, but a ceramic component, such as a varistor, is generally provided with an insulating layer covering a surface of a ceramic body in order to enhance electrical characteristics, for example, to reduce a leakage current, for the purpose of enhancing an insulation property between internal electrodes and external electrodes.

When a ceramic component provided with such an insulating layer, in particular, undergoes a temperature change, such as a temperature cycle between high temperatures and low temperatures, a difference in thermal expansion coefficient among the external electrodes, the insulating layer, and the ceramic body causes a concentration of stress on ends of the external electrodes. This may result in formation of cracks in the vicinity of the ends of the external electrodes, and in the vicinity of the ends of the external electrodes, peeling may occur between the insulating layer and the external electrodes, or between the insulating layer and the ceramic body.

### SUMMARY

It is an object of the present disclosure to provide a ceramic component configured to suppress both formation of cracks and peeling of an insulating layer from a ceramic body and/or an external electrode in the vicinity of an end of the external electrode.

A ceramic component according to an aspect of the present disclosure includes: a ceramic body; an internal electrode in an interior of the ceramic body; an insulating layer covering a surface of the ceramic body; and an external electrode covering part of the insulating layer and electrically connected to the internal electrode. The insulating layer includes a buffer layer in contact with at least one of the ceramic body or the external electrode.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a schematic sectional view of a ceramic component of a first embodiment; and

FIG. 2 is a schematic sectional view of a ceramic component of a second embodiment.

### DETAILED DESCRIPTION

### 1. Overview

The overview of a ceramic component 1 will be described with reference to the drawings. Note that the drawing is a schematic representation. Thus, the sizes, thicknesses, and other attributes of the respective constituent elements illustrated on the drawing are not always to scale, compared with actual ones.

As described above, when the ceramic component provided with the insulating layer undergoes the temperature change, the difference in thermal expansion coefficient among the external electrodes, the insulating layer, and the ceramic body concentrates stress on the ends of the external electrodes, which may result in the formation of cracks and the peeling between the insulating layer and the external electrodes or between the insulating layer and the ceramic body in the vicinity of the ends of the external electrodes.

The inventors conducted intensive studies on the ceramic component and found that imparting a specific property to part of the insulating layer of the ceramic component can solve the problem described above. The inventors have thus accomplished the present disclosure.

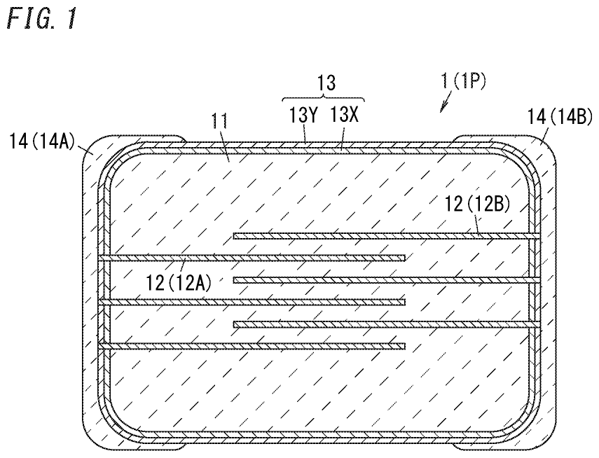

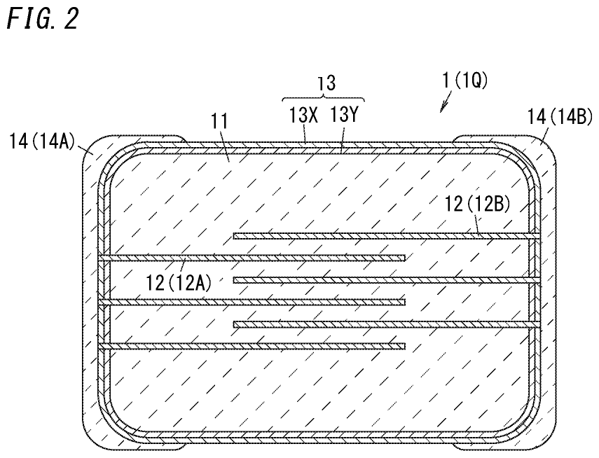

As shown in FIGS. 1 and 2, the ceramic component 1 of the present embodiment includes a ceramic body 11, internal electrodes 12 in an interior of the ceramic body 11, an insulating layer 13 covering a surface of the ceramic body 11, and external electrodes 14 covering part of the insulating layer 13 and electrically connected to the internal electrodes 12. In the ceramic component 1, the insulating layer 13 includes a buffer layer 13X in contact with at least one of the ceramic body 11 or the external electrodes 14. That is, the insulating layer 13 of the ceramic component 1 includes: the buffer layer 13X facing at least one of the ceramic body 11 or the external electrodes 14; and a portion 13Y (hereinafter also referred to as another layer 13Y) which is on an opposite side of the buffer layer 13X from the ceramic body 11 or the external electrodes 14 and which is a portion except for the buffer layer 13X.

In the ceramic component 1 of the present embodiment, the insulating layer 13 includes the buffer layer 13X on the side of the ceramic body 11 and/or the side of the external electrodes 14. Since the ceramic component 1 includes the buffer layer 13X as described above, the ceramic component 1 can suppress both the formation of cracks and the occurrence of peeling of the insulating layer 13 from the ceramic body 11 and/or the external electrodes 14 in the vicinity of ends of the external electrodes 14. That is, the ceramic component 1 of the present embodiment is excellent in both crack suppressibility and peeling suppressibility of the insulating layer 13 from the ceramic body 11 and/or the external electrodes 14 in the vicinity of the ends of the external electrodes 14. The reason why these suppressing effects are produced is presumed to be, for example, that the presence of the buffer layer 13X reduces the concentration of stress caused in the vicinity of the ends of the external electrodes 14 due to the difference in the thermal expansion coefficient of the insulating layer 13 from the ceramic body 11 and/or the external electrodes 14.

As described above, the present disclosure can suppress both the formation of cracks and the peeling of the insulating layer from the ceramic body and/or the external electrodes in the vicinity of the ends of the external electrodes.

### 2. Details

### <Ceramic Component>

The ceramic component 1 of the present embodiment includes the ceramic body 11, the internal electrodes 12, the insulating layer 13, and the external electrodes 14. The ceramic component 1 may further include plating electrodes. Examples of the ceramic component 1 of the present embodiment include varistors, thermistors, and ceramic capacitors. An example will be described in which the ceramic component 1 of the present embodiment is a varistor 1.

A ceramic component 1P of a first embodiment of the present disclosure is shown in FIG. 1. A ceramic component 1Q of a second embodiment of the present disclosure is shown in FIG. 2. In the ceramic component 1P of the first embodiment, an insulating layer 13 includes a buffer layer 13X in contact with a ceramic body 11. As shown in FIG. 1, the insulating layer 13 further includes another layer (hereinafter also referred to as an outer layer) 13Y positioned on an opposite side of the buffer layer 13X from the ceramic body 11. In the ceramic component 1Q of the second embodiment, an insulating layer 13 includes a buffer layer 13X in contact with an external electrodes 14. As shown in FIG. 2, the insulating layer 13 further includes another layer (hereinafter also referred to as an inner layer) 13Y positioned on an opposite side of the buffer layer 13X from the external electrodes 14.

The varistor 1 includes at least one pair of internal electrodes 12 and at least one pair of external electrodes 14. The varistor 1 shown in each of FIGS. 1 and 2 includes six (three pairs of) internal electrodes 12 and two (one pair of) external electrodes 14. The internal electrodes 12 include, for example, three first internal electrodes 12A and three second internal electrodes 12B. The external electrodes 14 include a first external electrode 14A disposed on one end surface of the ceramic body 11 and a second external electrode 14B disposed on the other end surface of the ceramic body 11, for example. The first internal electrodes 12A are electrically connected to the first external electrode 14A, and the second internal electrodes 12B are electrically connected to the second external electrode 14B. In the varistor 1, one of the first external electrode 14A and the second external electrode 14B is an electrode on a high-potential side, and the other is an electrode on a low-potential side.

### [Ceramic Body]

The ceramic body 11 in the varistor 1 is in the shape of, for example, a rectangular parallelepiped. The dimension of the ceramic body 11 is, for example, 0.6 mm to 2.0 mm in long side, 0.3 mm to 1.2 mm in width, and 0.3 mm to 1.2 mm in height. The ceramic body 11 may have corners accordingly beveled, or the corners of the ceramic body 11 may be rounded.

In the varistor 1, the ceramic body 11 is made of a semiconductor ceramic component having, for example, a nonlinear resistance characteristic. The ceramic body 11 generally includes ZnO as a major component and may include Bi₂O₃, Co₂O₃, MnO₂, Sb₂O₃, Pr₆O₁₁, CaCO₃, Cr₂O₃, etc., as minor components. The ceramic body 11 is formed by, for example, sintering the major component such as ZnO and some of the minor components in the semiconductor ceramic component to form a solid solution and to cause the remaining minor components to deposit on grain boundaries between the major component and the minor components.

### [Internal Electrode]

The internal electrodes 12 are disposed in the interior of the ceramic body 11. Examples of metal included in the internal electrodes 12 include Ag, Pd, PdAg, and PtAg. The ceramic body 11 including the internal electrodes 12 disposed in the interior thereof is formed by, for example, stacking one on top of another ceramic sheets to which an internal electrode paste containing one or more selected from these metals has been applied, and baking the ceramic sheets.

### [Insulating Layer]

The insulating layer 13 covers the surface of the ceramic body 11. The insulating layer 13 may cover part of the ceramic body 11 or may cover the entire surface of the ceramic body 11. Preferably, the insulating layer 13 covers regions which are included in the ceramic body 11 and which include the vicinity of the ends of the external electrodes 14. More preferably, the insulating layer 13 covers the entire surface of the ceramic body 11. In the ceramic component 1P of FIG. 1, the buffer layer 13X is disposed to cover the entire surface of the ceramic body 11, and the another layer (the outer layer) 13Y is disposed to cover the entire surface of the buffer layer 13X. In the ceramic component 1Q of FIG. 2, the another layer (the inner layer) 13Y is disposed to cover the entire surface of the ceramic body 11, and the buffer layer 13X is disposed to cover the entire surface of the another layer (the inner layer) 13Y.

In the ceramic component 1P of the first embodiment, the buffer layer 13X is a layer in contact with the ceramic body 11. In the ceramic component 1P, the insulating layer 13 includes the buffer layer 13X and the another layer (the outer layer) 13Y which is a portion of the insulating layer 13 except for the buffer layer 13X. The another layer (the outer layer) 13Y is a layer positioned on an opposite side of the buffer layer 13X from the ceramic body 11. The buffer layer 13X in the ceramic component 1P can relieve stress caused in the external electrodes 14, the insulating layer 13, and the ceramic body 11.

Moreover, in the ceramic component 1Q of the second embodiment, the buffer layer 13X is a layer in contact with the external electrodes 14. In the ceramic component 1Q, the insulating layer 13 includes the buffer layer 13X and the another layer (the inner layer) 13Y which is a portion of the insulating layer 13 except for the buffer layer 13X. The another layer (the inner layer) 13Y is a layer positioned on an opposite side of the buffer layer 13X from the external electrodes 14. The buffer layer 13X in the ceramic component 1Q can relieve stress caused in the external electrodes 14 and the insulating layer 13.

The buffer layer 13X has an average thickness, for example, greater than or equal to 1 nm and less than or equal to 1000 nm, preferably greater than or equal to 5 nm and less than or equal to 200 nm, more preferably greater than or equal to 10 nm and less than or equal to 100 nm. The outer layer 13Y has an average thickness, for example, greater than or equal to 10 nm and less than or equal to 10000 nm, preferably greater than or equal to 100 nm and less than or equal to 1000 nm, and more preferably greater than or equal to 200 nm and less than or equal to 500 nm. The “average thickness” means an arithmetic mean value of thicknesses measured at a plurality of points (e.g., ten arbitrary points) on a cross-sectional surface of the ceramic component.

Examples of a material for each of the buffer layer 13X and the another layer (the outer layer or the inner layer) 13Y include SiO₂, SiN, TiN, and Al₂O₃. Among them, SiO₂ is highly insulating and is thus preferable, and SiO₂ is more preferably a material for both the buffer layer 13X and the another layer 13Y. The case where the ceramic body 11 includes ZnO as a major component and the insulating layer 13 includes SiO₂ suppresses interdiffusion in the ceramic component 1 and is thus preferable.

The buffer layer 13X and the another layer 13Y are preferably identical in terms of a composition. Employing the buffer layer 13X and the another layer 13Y which are identical in terms of composition enables the insulating layer 13 to be formed more easily and conveniently. The “composition” means types of substances and the like included in each layer and the content ratio (% by mass) of each of the substances. Saying that the layers are “identical in terms of composition” means that substances included in the buffer layer 13X and substances included in the another layer 13Y are 95% or higher, preferably 99% or higher, the same substances by mass. When the buffer layer 13X and the another layer 13Y are identical in terms of composition, the buffer layer 13X and the another layer 13Y have the same linear expansivity and the same Poisson's ratio indicating the ratio of deformation in directions orthogonal to each other but may be different in terms of Young's modulus, particle size of particles included in the layers, porosity, and the like, as shown below.

Each of the buffer layer 13X and the another layer 13Y included in the insulating layer 13 can be formed by, for example, atomic layer deposition (ALD), chemical vapor deposition (CVD), or physical vapor deposition (PVD). In general, layers formed by the above-mentioned method are baked at a temperature of about 600° C. to 1200° C., thereby obtaining the buffer layer 13X and the another layer 13Y.

The Young's modulus of the buffer layer 13X (hereinafter also referred to as Young's modulus (X)) is preferably lower than the Young's modulus of the another layer 13Y (hereinafter also referred to as Young's modulus (Y)). Reducing the Young's modulus (X) to be lower than the Young's modulus (Y) further enhances a stress-relieving property of the buffer layer 13X, which can further improve both the crack suppressibility and the peeling suppressibility of the varistor 1. The Young's modulus (X) and the Young's modulus (Y) can be measured by, for example, using a nanoindentation method based on ISO14577.

The Young's modulus (X) is, for example, higher than or equal to 10 GPa and lower than or equal to 60 GPa, preferably higher than or equal to 18 GPa and lower than or equal to 55 GPa. The Young's modulus (Y) is, for example, higher than or equal to 50 GPa and lower than or equal to 100 GPa, preferably higher than or equal to 70 GPa and lower than or equal to 80 GPa.

A ratio of the Young's modulus (X) to the Young's modulus (Y) (buffer layer 13X/another layer 13Y) (hereinafter also referred to as a Young's modulus ratio) is preferably less than or equal to 0.9, more preferably less than or equal to 0.8, much more preferably less than or equal to 0.5, particularly preferably less than or equal to 0.3. The Young's modulus ratio is, for example, higher than or equal to 0.1.

When the buffer layer 13X and the another layer 13Y are formed by the ALD, the Young's modulus (X) and the Young's modulus (Y) are adjustable based on conditions such as the degree of vacuum, discharge energy, and temperature in the ALD. That is, the higher the degree of vacuum, the higher the Young's modulus, the higher the discharge energy, the lower the Young's modulus, and the higher the temperature, the lower the Young's modulus.

The buffer layer 13X and the another layer 13Y of the insulating layer 13 generally include particles.

The particle size of the particles included in the buffer layer 13X (hereinafter also referred to as a particle size (X)) is preferably larger than the particle size of the particles included in the another layer 13Y (hereinafter also referred to as a particle size (Y)). The particle size (X) being larger than the particle size (Y) further enhances the stress-relieving property of the buffer layer 13X, which can further improve both the crack suppressibility and the peeling suppressibility of the varistor 1. The “particle size” means, for example, the longest diameter of a particle measured by using, for example, a scanning electron microscope (SEM) and is an arithmetic mean value of particle sizes obtained by measuring a plurality of particles (e.g., ten arbitrary particles).

The particle size (X) is, for example, larger than or equal to 0.1 nm and smaller than or equal to 100 nm, preferably larger than or equal to 1 nm and smaller than or equal to 20 nm. The particle size (Y) is, for example, larger than or equal to 0.01 nm and smaller than or equal to 10 nm, preferably larger than or equal to 0.1 nm and smaller than or equal to 1 nm.

The ratio of the particle size (X) to the particle size (Y) (buffer layer 13X/another layer 13Y) (hereinafter also referred to as a particle size ratio) is preferably higher than or equal to 1.1, more preferably higher than or equal to 1.5, much more preferably higher than or equal to 2.0. The particle size ratio is, for example, lower than or equal to 10.

The porosity of the buffer layer 13X (hereinafter also referred to as a porosity (X)) is preferably higher than the porosity of the another layer 13Y (hereinafter also referred to as a porosity (Y)). The porosity (X) being higher than the porosity (Y) further enhances the stress-relieving property of the buffer layer 13X, thereby further improving both the crack suppressibility and the peeling suppressibility of the varistor 1. The “porosity” is the percentage (%) of the area of pores in a unit area of a cross-sectional surface of the buffer layer or the another layer and can be measured by using, for example, a transmission electron microscope (TEM).

The porosity (X) is, for example, higher than or equal to 0.1% and lower than or equal to 20%, preferably higher than or equal to 1.0% and lower than or equal to 10%. The porosity (Y) is, for example, higher than or equal to 0.001% and lower than or equal to 1.0%, preferably higher than or equal to 0.01% and lower than or equal to 0.1%.

The ratio of the porosity (X) to the porosity (Y) (buffer layer 13X/another layer 13Y) (hereinafter also referred to as a ratio of the porosity) is preferably higher than or equal to 1.1, more preferably higher than or equal to 2.0, much more preferably higher than or equal to 10. The ratio of the porosity is, for example, lower than or equal to 100.

The insulating layer 13 may include two layers, a buffer layer in contact with the ceramic body 11 and a buffer layer in contact with the external electrodes 14, as the buffer layer 13X. The insulating layer 13, including the two buffer layers and including the buffer layers 13X on both sides of the another layer 13Y, can further improve the crack suppressibility of the varistor 1 and can suppress peeling of the insulating layer 13 from the ceramic body 11 and the external electrodes 14.

### [External Electrode]

The external electrodes 14 cover at least part of the insulating layer 13 and are electrically connected to the internal electrodes 12.

The external electrode 14 has an average thickness, for example, greater than or equal to 1 μm and less than or equal to 50 μm, preferably greater than or equal to 5 μm and less than or equal to 25 μm.

The external electrodes 14 include a metal component (Ag, AgPd, AgPt, etc.) and a glass component (Bi₂O₃, SiO₂, B₂O₃, etc.). The external electrodes 14 preferably include the metal as the major component, more preferably Ag as the major component.

The external electrodes 14 may have a single layer structure (the external electrode 14A and the external electrode 14B) or may have a multilayer structure including a plurality of layers.

Each external electrode 14 is generally formed by applying an external electrode paste containing the metal component to part of a surface of the insulating layer 13 and firing the external electrode paste.

### [Plated Electrode]

The plating electrodes cover at least part of the external electrodes 14. The plating electrodes include, for example: a Ni plating layer covering at least part of the external electrodes 14; and a Sn plating layer covering at least part of the Ni plating layer.

The Ni plating layer has an average thickness, for example, greater than or equal to 1 μm and less than or equal to 5 μm, preferably greater than or equal to 0.5 μm and less than or equal to 3 μm. The Sn plating layer has an average thickness, for example, greater than or equal to 1 μm and less than or equal to 20 μm, preferably greater than or equal to 3 μm and less than or equal to 10 μm.

The ceramic component 1, such as a thermistor or a ceramic capacitor other than the varistor 1, of the present embodiment is also inferred to be able to suppress both the formation of cracks and the peeling of the insulating layer 13 from the ceramic body 11 and/or the external electrodes 14 in the vicinity of the ends of the external electrodes 14.

### <Method for Manufacturing Ceramic Component>

A method for manufacturing the ceramic component of the present embodiment (hereinafter also referred to as a manufacturing method (P)) includes first to fourth steps. The manufacturing method (P) may further include, as a fifth step, forming the plating electrodes.

### [First Step]

The first step includes forming the ceramic body 11 including the internal electrodes 12 in the interior of the ceramic body 11.

In the first step, an internal electrode paste is applied to ceramic sheets produced from a slurry including, for example, ZnO, and the ceramic sheets are stacked one on top of another, are pressed, are cut, and are then debindered and baked, thereby producing the ceramic body 11 including the internal electrodes 12 in the interior of the ceramic body 11. The slurry can be prepared, for example, by mixing together the following substances: ZnO which is a main raw material; Bi₂O₃, Co₂O₃, MnO₂, Sb₂O₃, Pr₆O₁₁, CaCO₃, Cr₂O₃, etc., as minor raw materials; and a binder.

Examples of the internal electrode paste include a Ag-paste, a Pd-paste, a Pt-paste, a PdAg-paste, and a PtAg-paste.

A temperature at which the debindering is performed is, for example, higher than or equal to 300° C. and lower than or equal to 500° C. A temperature at which the baking is performed is adjustable accordingly based on the configuration, composition, etc., of the ceramic body 11 to be formed and is, for example, higher than or equal to 800° C. and lower than or equal to 1300° C.

### [Second Step]

The second step includes forming the buffer layer 13X or the another layer (the inner layer) 13Y as part of the insulating layer 13, on the surface of the ceramic body 11.

Examples of a formation method of the buffer layer 13X and the another layer (the inner layer) 13Y in the second step include methods using ALD, CVD, and PVD.

In the ALD, introducing a gaseous precursor and radiating O₂ plasma, Ar plasma, etc., to a surface, on which a layer is to be formed, for example, of the ceramic body 11 are repeated, thereby forming the layer including an atom layer sediment.

To form a SiO₂ layer, for example, bis(ethylmethylamino)silane (BEMAS) is used as a precursor, which is then irradiated with O₂ plasma.

To vary the Young's modulus of the buffer layer 13X and the another layer (the inner layer) 13Y to be formed by the ALD, as described above, conditions such as the degree of vacuum, discharge energy, and temperature in the ALD may be adjusted. The degree of vacuum is, for example, higher than or equal to 0.1 Pa and lower than or equal to 10 Pa, preferably higher than or equal to 1 Pa and lower than or equal to 5 Pa. The discharge energy is, for example, greater than or equal to 1 kW and less than or equal to 5 KW, preferably greater than or equal to 2 kW and less than or equal to 2.5 kW. The temperature is, for example, higher than or equal to 20° C. and lower than or equal to 200° C., preferably higher than or equal to 50° C. and lower than or equal to 150° C.

As the CVD, for example, plasma CVD is used. In the plasma CVD, a gas for plasma reaction is introduced to a surface on which a layer is to be formed, and the gas is activated or polymerized by plasma discharge, thereby forming the layer.

To form the SiO₂ layer, for example, hexamethyldisiloxane (HMDSO) is used as the gas for plasma reaction, and O₂ is used as an oxidant.

In the PVD, a layer can be formed by vacuum deposition, sputtering, ionic plating, or the like. The SiO₂ layer can be formed by, for example, the vacuum deposition of SiO₂.

In the second step, baking is performed after the layer described above is formed. The temperature of the baking is generally about 600° C. to about 900° C., preferably higher than or equal to 700° C. and lower than or equal to 800° C. This can form the buffer layer 13X or the another layer (the inner layer) 13Y. Moreover, instead of the baking performed in the second step, firing of the external electrodes may be performed in the fourth step to form the buffer layer 13X and the another layer (the inner layer) 13Y.

### [Third Step]

The third step includes forming, as part of the insulating layer 13, another layer (the outer layer) 13Y or the buffer layer 13X respectively on a surface of the buffer layer 13X or the another layer (the inner layer) 13Y formed in the second step.

A formation method of the another layer (the outer layer) 13Y and the buffer layer 13X in the third step may be a method similar to the formation method of the buffer layer 13X and the another layer (the inner layer) 13Y in the second step, but in the third step, formation conditions and the like may be changed from those in the second step, and thereby, the another layer (the outer layer) 13Y and the buffer layer 13X different from the buffer layer 13X and the another layer (the inner layer) formed in the second step in terms of physical properties and the like can be formed. Moreover, in the third step, baking may be performed in a similar manner to the second step.

The manufacturing method may include, after the third step, a step of forming a buffer layer 13X as part of the insulating layer 13 on a surface of the another layer 13Y formed in the third step. This can form the insulating layer 13 having a layered structure of buffer layer/another layer/buffer layer.

### [Fourth Step]

The fourth step includes forming the external electrodes 14 on part of a surface of the another layer (the outer layer) 13Y or the buffer layer 13X formed in the third step.

In the fourth step, an external electrode paste is applied to, for example, the part of the surface of the another layer (the outer layer) 13Y or the buffer layer 13X so as to come into contact with part of the internal electrodes 12 and is then fired, thereby forming the external electrodes 14. The external electrode paste can be prepared, for example, by mixing: a metal component including a Ag powder, a AgPd powder, a AgPt powder, etc.; a glass component including Bi₂O₃, SiO₂, B₂O₃, etc.; and a solvent. Moreover, as the external electrode paste, for example, a paste may also be used which includes: Ag as a major component; and a resin component. Examples of an application method of the external electrode paste include immersion and screen printing. A temperature for the firing is, for example, higher than or equal to 700° C. and lower than or equal to 800° C.

### [Fifth Step]

The fifth step includes forming the plating electrodes to cover at least part of the external electrodes 14. Examples of a formation method of the plating electrodes include sequentially performing Ni plating and Sn plating by an electrolytic plating method. Examples

The present disclosure will be more specifically described below with reference to examples, but the present disclosure is not limited to the examples.

### <Manufacturing of Ceramic Component>

On a surface of a ceramic body including ZnO as a major component, a buffer layer and another layer (an outer layer or an inner layer) were formed to be an insulating layer having a layered structure shown in Table 1 below by atomic layer deposition (ALD). Next, on a surface of the insulating layer thus formed, external electrodes (average thickness: 5 to 25 μm, Young's modulus: 73.2 GPa) were formed from an external electrode paste including silver as a major component. Then, on surfaces of the external electrodes, a Ni plating layer (average thickness: 0.5 to 3 μm, Young's modulus: 201 GPa) and a Sn plating layer (average thickness: 3 to 10 μm, Young's modulus: 49.9 GPa) were sequentially formed by electrolytic plating, thereby manufacturing a ceramic component.

Formation of a SiO₂ layer by ALD was performed by: introducing bis(ethylmethylamino)silane (BEMAS) as a precursor, thereby forming a Si-containing layer; and then performing purging, followed by irradiating the Si-containing layer thus formed with O₂ plasma.

### Example 1

A ceramic component of Example 1 includes, as an insulating layer, a buffer layer in contact with a ceramic body and another layer (an outer layer) on an opposite side of the buffer layer from the ceramic body. As the ceramic component of Example 1, a plurality of ceramic components whose average thickness of the buffer layer is within the range of 10 to 100 nm were manufactured, and a plurality of ceramic components whose average thickness of the another layer (the outer layer) is within the range of 200 to 500 nm were manufactured.

### Example 2

A ceramic component of Example 2 includes, as an insulating layer, a another layer (an inner layer) in contact with a ceramic body; and a buffer layer on an opposite side of the another layer (the inner layer) from the ceramic body. As the ceramic component of Example 2, a plurality of ceramic components whose average thickness of the another layer (the inner layer) is within the range of 200 to 500 nm were manufactured, and a plurality of ceramic components whose average thickness of the buffer layer is within the range of 10 to 100 nm were manufactured.

### Example 3

A ceramic component of Example 3 includes, as an insulating layer: a first buffer layer in contact with a ceramic body; another layer positioned on an opposite side of the first buffer layer from the ceramic body; and a second buffer layer on an opposite side of the another layer from the ceramic body. As the ceramic component of Example 3, a plurality of ceramic components whose average thickness of the first buffer layer is within the range of 10 to 100 nm were manufactured, a plurality of ceramic components whose average thickness of the another layer is within the range of 200 to 500 nm were manufactured, and a plurality of ceramic components whose average thickness of the second buffer layer is within the range of 10 to 100 nm were manufactured.

### Comparative Example 1

A ceramic component of Comparative Example 1 includes, as an insulating layer, only another layer in contact with a ceramic body. As the ceramic component of Comparative Example 1, a plurality of ceramic components whose average thickness of the another layer is within the range of 200 to 500 nm were manufactured.

### <Evaluations>

Each of the ceramic components thus manufactured was evaluated in terms of the crack suppressibility and the peeling suppressibility by the following method.

### (Production of Evaluation Sample)

The ceramic components thus manufactured, two hundred ceramic components for each of the examples, were subjected to 2000 cycles of a temperature change between −50° C. and +150° C., thereby obtaining evaluation samples.

### (Crack Suppressibility)

The two hundred evaluation samples thus produced were checked by using a microscope for formation of cracks in the vicinity of ends of the external electrodes, and the number of evaluation samples in which the formation of cracks was observed was obtained. The crack suppressibility was evaluated as A (good) in the case of no cracks observed in any of the samples and as B (poor) in the case of cracks observed in one or more samples.

### (Peeling Suppressibility)

The two hundred evaluation samples thus produced were checked by using the microscope as to whether or not peeling occurred between the insulating layer and the ceramic body or the external electrodes in the vicinity of the ends of the external electrodes, and the number of evaluation samples in which the peeling was observed was obtained. The peeling suppressibility was evaluated as A (good) in the case of no peeling observed in any of the samples and as B (poor) in the case of peeling observed in one or more samples.

Table 1 below shows evaluation results of the crack suppressibility and the peeling suppressibility together with the layered structure of the insulating layer in each ceramic component.

TABLE 1

| | Layered | | Aver- | | | |
|---|---|---|---|---|---|---|
| | Structure | | age | | Evaluation | |
| | of | | Thick- | Young's | Crack | Peel |
| | Insulating | Mate- | ness | Modulus | Suppres- | Suppres- |
| | Layer | rial | (nm) | (GPa) | sibility | sibility |
| Exam- | Buffer | SiO₂ | 10-100 | 18.3-54.9 | A | A |
| | Layer | | | | | |
| ple 1 | Another | SiO₂ | 200-500 | 73.1 | | |
| | Layer | | | | | |
| | (Outer | | | | | |
| | Layer) | | | | | |
| Exam- | Another | SiO₂ | 200-500 | 73.1 | A | A |
| ple 2 | Layer | | | | | |
| | (Inner | | | | | |
| | Layer) | | | | | |
| | Buffer | SiO₂ | 10-100 | 18.3-54.9 | | |
| | Layer | | | | | |
| Exam- | First | SiO₂ | 10-100 | 18.3-54.9 | A | A |
| ple 3 | Buffer | | | | | |
| | Layer | | | | | |
| | Another | SiO₂ | 200-500 | 73.1 | | |
| | Layer | | | | | |
| | Second | SiO₂ | 10-100 | 18.3-54.9 | | |
| | Buffer | | | | | |
| | Layer | | | | | |
| Com- | Another | SiO₂ | 200-500 | 73.1 | B | B |
| par- | Layer | | | | | |
| ative | | | | | | |
| Exam- | | | | | | |
| ple 1 | | | | | | |

As can be seen from the results in Table 1, the ceramic components of Examples 1, 2, and 3 are excellent in both the crack suppressibility and the peeling suppressibility. The ceramic component of Comparative Example 1 is poor in both the crack suppressibility and the peeling suppressibility.

### SUMMARY

As can be seen from the embodiment described above, the present disclosure includes the following aspects. In the following description, reference signs in parentheses are added only to clarify the correspondence relationship to the embodiment.

A ceramic component (1) of a first aspect includes: a ceramic body (11); an internal electrode (12) in an interior of the ceramic body (11); an insulating layer (13) covering a surface of the ceramic body (11), and an external electrode (14) covering part of the insulating layer (13) and electrically connected to the internal electrode (12). The insulating layer (13) includes a buffer layer (13X) in contact with at least one of the ceramic body (11) or the external electrode (14).

The first aspect enables the ceramic component (1) to suppress both formation of cracks and peeling of the insulating layer (13) from the ceramic body (11) and/or the external electrode (14) in the vicinity of an end of the external electrode (14).

In a ceramic component (1) of a second aspect referring to the first aspect, the buffer layer (13X) is in contact with the ceramic body (11).

The second aspect enables both formation of cracks and peeling between the insulating layer (13) and the ceramic body (11) in the vicinity of the end of the external electrode (14) to be suppressed in the ceramic component (1).

In a ceramic component (1) of a third aspect referring to the first or second aspect, the buffer layer (13X) is in contact with the external electrode (14).

The third aspect enables both the formation of cracks and the peeling between the insulating layer (13) and the external electrode (14) in the vicinity of the end of the external electrode (14) to be suppressed in the ceramic component (1).

In a ceramic component (1) of a fourth aspect referring to any one of the first to third aspects, a composition of the buffer layer (13X) and a composition of a portion (13Y) of the insulating layer (13) except for the buffer layer (13X) are identical.

The fourth aspect enables the insulating layer (13) to be formed more easily and conveniently.

In a ceramic component (1) of a fifth aspect referring to any one of the first or fourth aspects, Young's modulus of the buffer layer (13X) is lower than Young's modulus of a portion (13Y) of the insulating layer (13) except for the buffer layer (13X).

The fifth aspect enables both the crack suppressibility and the peeling suppressibility of the ceramic component (1) to be further improved.

In a ceramic component (1) of a sixth aspect referring to any one of the first to fifth aspects, a particle size of particles included in the buffer layer (13X) is larger than a particle size of particles included in a portion (13Y) of the insulating layer (13) except for the buffer layer (13X).

The sixth aspect enables both the crack suppressibility and the peeling suppressibility of the ceramic component (1) to be further improved.

In a ceramic component (1) of a seventh aspect referring to any one of the first to sixth aspects, a porosity of the buffer layer (13X) is higher than a porosity of a portion (13Y) of the insulating layer (13) except for the buffer layer (13X).

The seventh aspect enables both the crack suppressibility and the peeling suppressibility of the ceramic component (1) to be further improved.

In a ceramic component (1) of an eighth aspect referring to any one of the first to seventh aspects, the ceramic body (11) includes ZnO as a major component, and the insulating layer (13) includes SiO₂.

The eighth aspect suppresses interdiffusion in the ceramic component (1).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A ceramic component comprising:
a ceramic body;
an internal electrode in an interior of the ceramic body;
an insulating layer covering a surface of the ceramic body, and
an external electrode covering part of the insulating layer and electrically connected to the internal electrode,
the insulating layer including a buffer layer in contact with at least one of the ceramic body or the external electrode.

2. The ceramic component of claim 1, wherein
the buffer layer is in contact with the ceramic body.

3. The ceramic component of claim 1, wherein
the buffer layer is in contact with the external electrode.

4. The ceramic component of claim 1, wherein
a composition of the buffer layer and a composition of a portion of the insulating layer except for the buffer layer are identical.

5. The ceramic component of claim 1, wherein
Young's modulus of the buffer layer is lower than Young's modulus of a portion of the insulating layer except for the buffer layer.

6. The ceramic component of claim 1, wherein
a particle size of particles included in the buffer layer is larger than a particle size of particles included in a portion of the insulating layer except for the buffer layer.

7. The ceramic component of claim 1, wherein
a porosity of the buffer layer is higher than a porosity of a portion of the insulating layer except for the buffer layer.

8. The ceramic component of claim 1, wherein
the ceramic body includes ZnO as a major component, and
the insulating layer includes SiO₂.
